(19) United States
(12) Patent Application Publication
(10) Pub. No.: US 2015/0062649 A1
(43) Pub. Date: Mar. 5, 2015

(54) INFORMATION PROCESSING APPARATUS, PROGRAM, AND CONTROL METHOD

(71) Applicant: CANON KABUSHIKI KAISHA, Tokyo (JP)

(72) Inventor: Tomonori Minagawa, Yokohama-shi (JP)

(21) Appl. No.: 14/468,200

(22) Filed: Aug. 25, 2014

(30) Foreign Application Priority Data
Aug. 28, 2013 (JP) 2013-176245

(51) Int. Cl. H04N 1/00

(52) U.S. Cl. CPC H04N 1/00973; H04N 1/00925; H04N 2201/0094
USPC 358/1.16

(57) ABSTRACT

An information processing apparatus determines whether information indicating a creator of environment setting information described in the environment setting information is the same as information indicating a user of an application, and if it is determined that the information indicating a creator of the environment setting information is not the same as the information indicating a user of the application, imports the environment setting information in a state where a path to a folder to be used by the creator included in the environment setting information is unusable.

### BACKGROUND

1. Field

Aspects of the present invention generally relate to a technique for exporting and importing environment setting information of an application.

2. Description of the Related Art

A user sets environment setting information for an application. For example, the environment setting information includes a size and a position of an application screen, display order of icons and files, and a path to an operation folder. The user can improve operability of operations and work efficiency by setting the environment setting information according to a use case or a job workflow.

However, if the environment setting information includes a large number of setting items, an initial setting load after installation of an application increases. In particular, when the user changes a work environment to a new computer, or when re-installation of the application is required due to a system upgrade, it becomes necessary for the user to reset the environment setting information, which is burdensome.

To solve such an issue, there is a method for inheriting past environment setting information or the environment setting information generated by an administrator. Japanese Patent Application Laid-Open No. 2003-99267 discusses a technique in which setting change information of changes for an application is stored. When the application is reinstalled, the stored setting change information is read and the setting is changed.

However, with the technique discussed in Japanese Patent Application Laid-Open No. 2003-99267, there is a possibility that an operation intended by the user may not be realized. For example, if the environment setting information includes reference information of a folder or a file, such information may become unusable if there is a change in a version of an operating system (OS) or an apparatus which uses the environment setting information. In other words, when using the environment setting information, an operation intended by the user may not be realized.

### SUMMARY

Aspects of the present invention are generally directed to a technique for appropriately using environment setting information.

According to an aspect of the present invention, an image processing apparatus includes an identification unit configured to identify environment setting information in which setting contents of an application is described, a determination unit configured to determine whether information indicating a creator of the environment setting information described in the environment setting information is the same as information indicating a user of the application, and an import unit configured to import, in a case where the determination unit determines that the information indicating a creator of the environment setting information is not the same as the information indicating a user of the application, the environment setting information so that a path to a folder to be used by the creator included in the environment setting information is not applied to the application.

Further features of the present disclosure will become apparent from the following description of exemplary embodiments with reference to the attached drawings.

### BRIEF DESCRIPTION OF THE DRAWINGS

FIG. 1 is a diagram illustrating a system configuration.

FIG. 2 is a diagram illustrating a hardware configuration of an information processing apparatus.

FIG. 3 is a diagram illustrating a hardware configuration of an image processing apparatus.

FIG. 4 is a diagram illustrating a software configuration of a document management application.

FIG. 5 is a diagram illustrating a user interface (UI) screen of the application.

FIG. 6 is a table illustrating an example of environment setting information which is original environment setting information.

FIGS. 7A and 7B are diagrams each illustrating a UI screen for designating import and export of the environment setting information.

FIG. 8 is a flowchart illustrating export processing.

FIG. 9 is a flowchart illustrating import processing.

FIG. 10 is a flowchart illustrating substantial import processing.

FIG. 11 is a flowchart illustrating the import processing performed when an application is activated.

FIG. 12 is a table illustrating an example of export information.

FIG. 13 is a table illustrating an example of the environment setting information when the environment setting information is imported by distribution mode.

FIG. 14 is a table illustrating an example of the environment setting information when the environment setting information is imported by moving mode.

### DESCRIPTION OF THE EMBODIMENTS

Various exemplary embodiments will be described in detail below with reference to the drawings.

### [System Configuration]

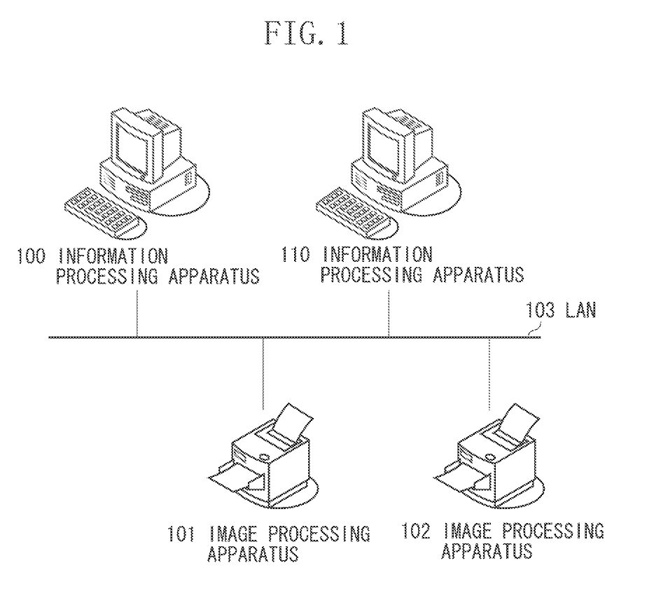

FIG. 1 is a diagram illustrating a configuration of a data processing system according to a first exemplary embodiment. According to the present exemplary embodiment, the data processing system is a system in which an information processing apparatus and an image processing apparatus described below are communicable via a network. Host computers (or information processing apparatuses) 100 and 110 instruct image processing apparatuses 101 and 102 to perform printing or facsimile transmission. The image processing apparatuses 101 and 102 include a printer function, a facsimile function, a copy function, a scanner function, and a file transmission function. A predetermined OS and various applications (not illustrated) for executing specific function processing are installed in the information processing apparatus 100 (110). The specific function processing includes document processing and spreadsheet processing, and each application has a unique data structure (i.e., file structure). Further, the OS is capable of referring to an identifier of each file and instructing printing to a corresponding application. The information processing apparatuses 100 and 110 and the image processing apparatuses 101 and 102 are communicably connected each other via a network 103. An example of the network 103 is a local area network (LAN).

A document management application 400 for performing document management and printing (which will be described below) is installed in the information processing apparatus 100 (110). The document management application 400 installed in the information processing apparatus 100 exports the environment setting information of the document management application 400. On the other hand, the document management application 400 installed in the information processing apparatus 110 imports the environment setting information which has been exported.

[Hardware Configuration (of the Information Processing apparatus)]

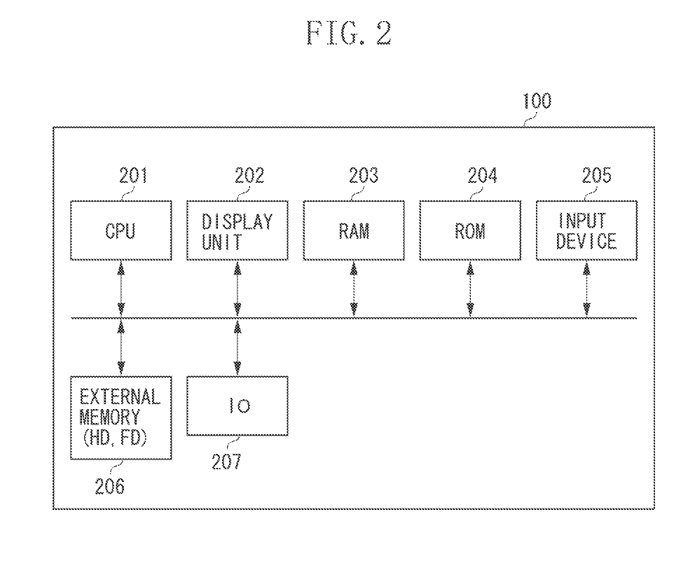

FIG. 2 is a diagram illustrating a hardware configuration of the information processing apparatus 100 (110) illustrated in FIG. 1. The information processing apparatus 100 (110) includes an input device 205, such as a keyboard or a pointing device, for receiving a user operation input. Further, the information processing apparatus 100 (110) includes a display unit 202 which feeds back visual output information to the user. Further, the information processing apparatus 100 (110) includes a random access memory (RAM) 203, a read-only memory (ROM) 204, and an external memory 206, such as a hard disk drive (HDD) and a floppy disk drive (FDD, registered trademark), for storing various programs and execution information according to the present exemplary embodiment. Moreover, the information processing apparatus 100 (110) includes an interface device input/output (I/O) 207 for communicating with an external device and a central processing unit (CPU) 201 which executes the programs. The information processing apparatus 100 (110) and peripheral devices may be connected each other using wired or wireless connection. The information processing apparatus 100 (110) connects to the image processing apparatuses 101 and 102 via the external device connection interface (I/F).

### [Hardware Configuration (of the Image Processing Apparatus)]

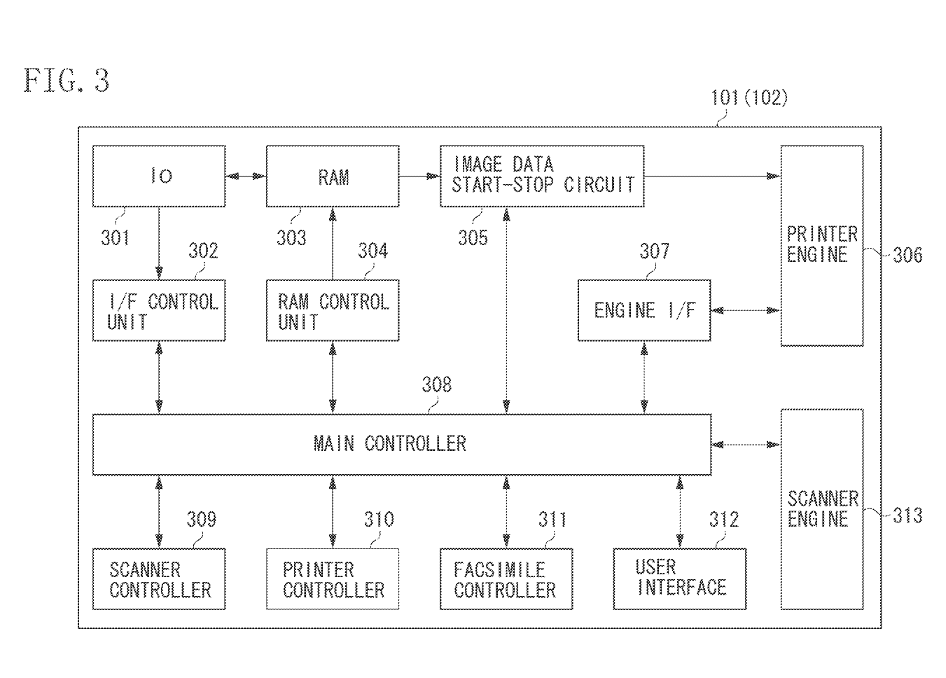

FIG. 3 is a block diagram illustrating a hardware configuration of the image processing apparatuses 101 and 102 illustrated in FIG. 1. According to the present exemplary embodiment, the image processing apparatus 101 (102) is a multifunction peripheral (MFP) including the scanner function, the printer function, and the facsimile function. An I/O 301 connects to the information processing apparatus via a communication medium, such as the network (LAN) 103. The image processing apparatus 101 (102) may include a plurality of I/O 301 for supporting a plurality of connection forms. The image processing apparatus 101 (102) transmits a device identification (ID) and a scanned image to the information processing apparatus 100 (110) via the I/O 301. Further, the image processing apparatus 101 (102) receives various control commands from the information processing apparatus 100 (110) via the I/O 301 and performs processing. An interface (I/F) control unit 302 issues the device ID for processing functions, such as the scanner (not illustrated) and the printer (not illustrated) included in the image processing apparatus 101 (102). A RAM 303, which is a temporary storage device, stores external data, such as the control commands obtained through the I/O 301 and the image read by a scanner engine 313. Further, the RAM 303 temporary stores image data converted by a printer controller 310 before transmitting to a printer engine 306.

A RAM control unit 304 performs allocation management for the RAM 303. An image data start-stop circuit 305 outputs the image imported by the printer controller 310 or the scanner engine 313 and converted by the RAM control unit 304, in accordance with rotation of the printer engine 306. The printer engine 306 develops the image on output media, such as a sheet. A main controller 308 performs various control for the printer engine 306 via an engine I/F 307. Further, the main controller 308 appropriately sorts a control language received from the information processing apparatus 100 (110) via the I/O 301 to a scanner controller 309, a printer controller 310, and a facsimile controller 311. Furthermore, the main controller 308 receives instructions from each of the controllers and a user interface 312, and controls the printer engine 306 and the scanner engine 313. The control interface between the main controller 308 and the various controllers is unified, so that an extension board capable of processing a plurality of types of control commands can be included in a peripheral device. Further, the main controller 308 obtains, from each controller, and manages the device ID of an extension controller which is currently included in the peripheral device. The scanner controller 309 decomposes a scan control command received from the information processing apparatus 100 (110) to an internal execution command interpretable by the main controller 308. Further, the scanner controller 309 changes the image read by the scanner engine 313 to the scan control command. The printer controller 310 decomposes a page description language received from the information processing apparatus 100 (110) to the internal execution command including a converted image in the page description language interpretable by the main controller 308. The printer engine 306 then prints the converted image on the output media, such as a sheet. The facsimile controller 311 converts a facsimile control language received from the information processing apparatus 100 (110) to an image and transfers the image to other facsimile apparatus or an internet protocol (IP) facsimile via a public line (not illustrated) or the Internet. The user interface 312 is used as an instruction input/output unit when the user sets the various settings of the main controller 308 and when the user directly executes the scanner function, the printer function, and the facsimile function in the image processing apparatus 101 (102). The scanner engine 313 reads an image printed by using an optical device according to an instruction from the main controller 308, converts the read image to an electric signal, and transmits the electric signal to the main controller 308.

### [Software Configuration]

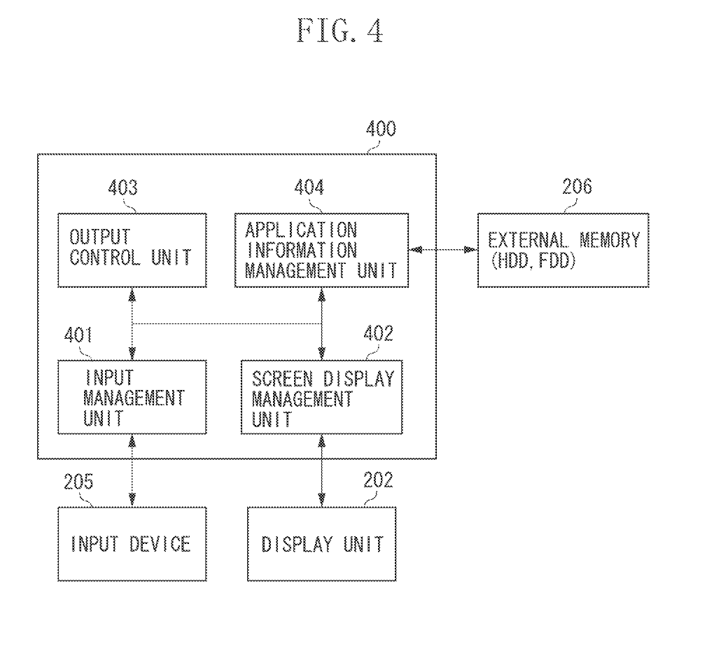

FIG. 4 is a diagram illustrating an example of a software configuration of the document management application 400 executed by the information processing apparatus 100 (110). The document management application 400 includes an input management unit 401, a screen display management unit 402, an output control unit 403, and an application information management unit 404.

The input management unit 401 detects a user operation on the input device 205 via a graphical user interface (GUI) of the document management application 400 displayed by the screen display management 402. The input management unit 401 thus obtains user operation information. Further, the input management unit 401 monitors an operation event of the mouse or the keyboard which is processed by the OS, in addition to the operation on the GUI displayed on the screen display management 402, and detects the user input operation.

The screen display management 402 performs processing related to image display control, for example, displaying the GUI of the document management application 400 and detecting the user operation on the GUI. Upon receiving the user operation on the GUI, the screen display management 402 instructs the output control unit 403 to perform corresponding processing according to the received operation.

The output control unit 403 performs various output processing according to the user operation received via the screen display management 402. For example, if a print instruction or a facsimile instruction is received, the output control unit 403 transmits an image to the image processing apparatus 101 (102) via a printer driver or a facsimile driver accordingly. Further, the output control unit 403 adds a stamp to a document and converts a file format according to the instruction.

The application information management unit 404 manages the settings and a status of the application while the document management application 400 is activating, and writes the settings and the status of the application in a setting file of the external memory 206. According to the present exemplary embodiment, the application information management unit 404 stores the environment setting information, such as the image size, library information (e.g., a name and the path), monitoring information, a registered stamp (i.e., the name and the image data), a file transfer function, and print setting information.

### [Document Management Application]

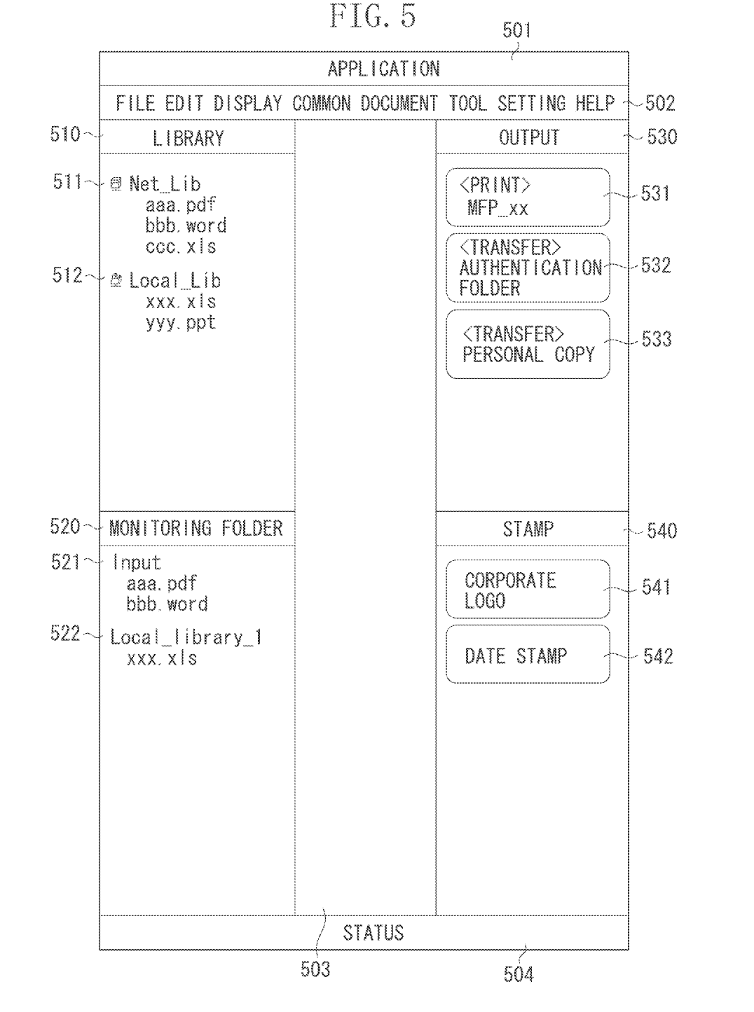

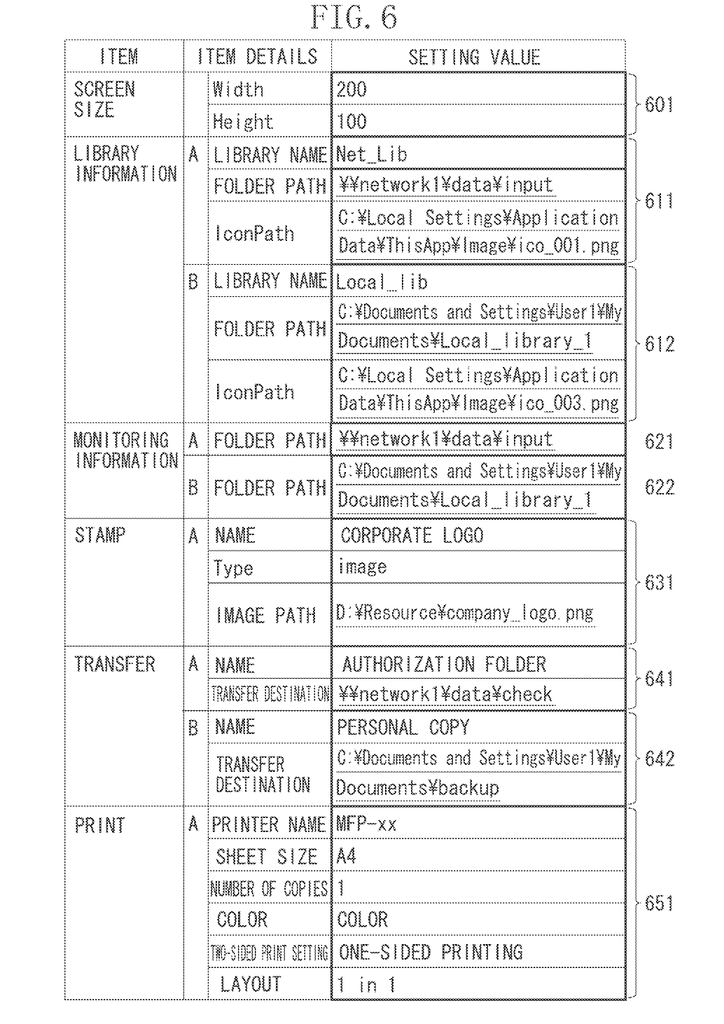

FIG. 5 is a diagram illustrating an example of the UI screen of the document management application 400. FIG. 6 is a table illustrating a list of the various types of environment setting information stored by the document management application 400.

A UI 501 of the document management application 400 includes a menu 502 for selecting the various functions, a preview and editing area 503, and a status bar 504. The screen size of the UI 501 is stored as setting values of screen size 601 in the environment setting information list illustrated in FIG. 6.

The preview and editing area 503 displays a preview image of the file selected on a library area 510. Further, if an editing mode is set, the user is capable of performing various types of editing. The status bar 504 displays as necessary the information on the selected file and the information on an operation currently being performed.

The library area 510 displays the folders which have been designated to be registered and managed as the library. The user is capable of designating various operations on the files in the folder registered in the library and issuing instructions for a thumbnail display, a preview display, division and copying of a portable document format (PDF) file, addition of a property, and printing. FIG. 5 illustrates an example in which two libraries, i.e., Net_Lib 511 and Local_Lib 512, are registered.

The Net_Lib 511 indicates the folder on the network (i.e., \\network1\data\input), and ico_{—}001.png is used as a display icon, as described in the setting values of library information A 611 illustrated in FIG. 6. Similarly, the Local_Lib 512 indicates a local folder and ico_{—}003.png is used as a display icon, as described in the setting values of library information B 612.

A monitoring folder area 520 displays the folders to be monitored. If a newly-arrived file is detected in the monitoring folder area 520, the user is notified of the newly-arrived file. FIG. 5 illustrates an example in which two monitoring folders (i.e., Input 521 and Local_Library 522) are registered. The document management application 400 monitors the folder on the network (i.e., \\netwrok1\data\input) indicated as a setting value of monitor information A 621 illustrated in FIG. 6 for monitoring the Input 521. On the other hand, the document management application 400 monitors the local folder indicated as a setting value of monitor information B 622 for monitoring the Local_Library 522.

An output area 530 displays buttons (or objects) for receiving designation of a method for outputting the file selected in the library. The method for outputting the file includes employing an <output> function for previewing and printing the selected file, and a <transfer> function for transferring the selected file to the folder designated by the user. FIG. 5 illustrates an example in which three buttons (i.e., a <print> button 531, <transfer> buttons 532 and 533) are registered.

If the user selects a file and then presses the <print> button 531 or drags and drops the selected file to the <print> button 531, the document management application 400 performs preview displaying and printing based on the selected file. A printer name of a connected printer and default settings for printing are designated in the <print> MFP_xx button 531 illustrated in FIG. 5, as indicated in the setting values of print A 651 illustrated in FIG. 6. When the user instructs printing, printing is performed via the printer driver of the corresponding printer.

A network folder (\\netwrok1\data\check) is designated as a transfer destination in the <transfer>authentication folder button 532 illustrated in FIG. 5 as indicated in the setting values of transfer A 641 illustrated in FIG. 6. If the user presses the <transfer> button 532 or drags and drops the selected file to the <transfer> button 532, the selected file is transferred to the designated folder. Similarly, a local folder is designated in the <transfer> personal copy button 533 as indicated in the setting values of transfer B 642 illustrated in FIG. 6.

A stamp area 540 displays the stamps to be added to the files selected in the library area 510. FIG. 5 illustrates an example in which two stamps (i.e., a corporate logo 541 and a date stamp 542) are registered. If the user instructs using the corporate logo 541, the image file existing in a D drive as indicated in the setting values of stamp A 631 illustrated in FIG. 6 is added to the selected file as the stamp of the corporate logo 541. The data stamp 542 is used for adding a date of use as a stamp to the selected file. In either case where the user opens the file in the editing mode and presses the stamp button, or drags and drops the selected file to the button in the stamp area 540, a stamp object is added to a designated position on the document.

An example in which the date stamp or the corporate logo is added on a facsimile-received file, and an authorization is requested to a next person-in-charge will be described below as a work flow of the document management application 400.

The facsimile document received by the MFP (the MFP_xx) is stored in the \\network1\data\input folder. The user registers the \\network1\data\input folder as the library (the Net_Lib 511). Further, the user registers the \\network1\data\input folder as the monitoring folder (Input 521). When the MFP_xx receives facsimile data, the facsimile data is stored in the \\network1\data\input folder. The document management application 400 then detects that new facsimile data has been stored in the monitoring folder, i.e., Input 521, and notifies on the screen that the newly-arrived file has been received.

The user selects the file corresponding to the facsimile data from the Input 521 or the Net_Lib 511, and adds the stamp (the corporate logo 541 or the date stamp 542). Further, the user executes printing by operating the <print> MFP_xx button 531. The user then presses the <transfer>authentication folder button 532, so that the facsimile data file is transferred to a folder (\\network1\data\check) managed by the next person-in-charge of authorization.

The user may designate a local library or a local monitoring folder in a separate workflow. For example, the user can store a backup in a personal folder by pressing the <transfer> personal copy button 533.

The operation of the document management application 400 and the method for storing the environment setting data according to the present exemplary embodiment are as described above.

### [Export of the Environment Setting Information]

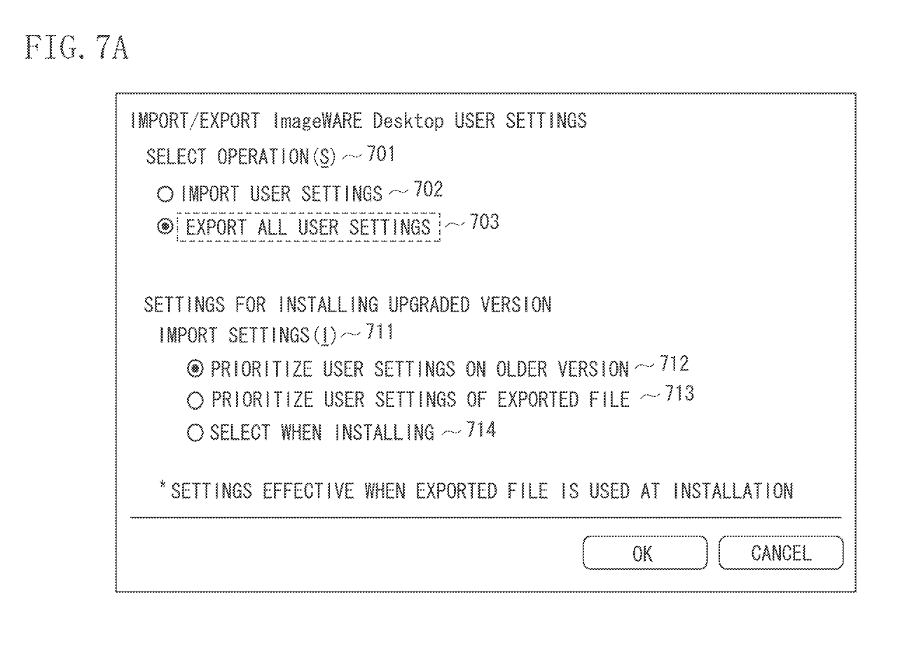

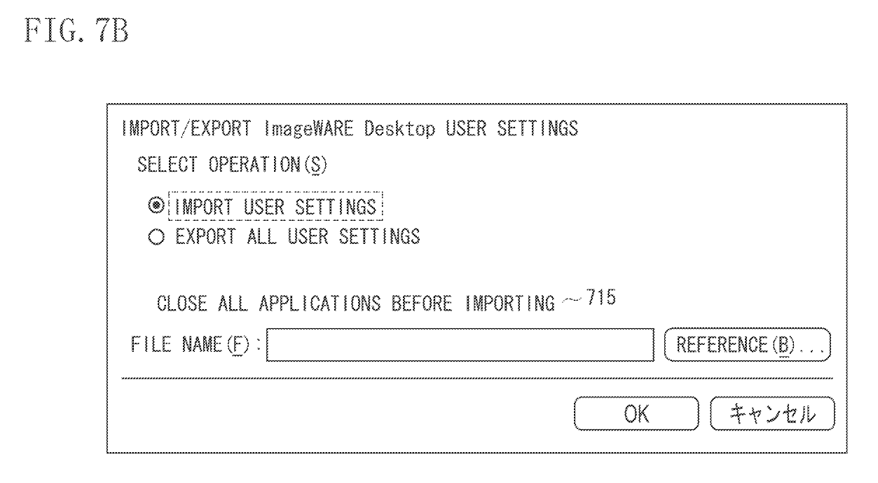

FIGS. 7A and 7B are diagrams each illustrating an example of a UI screen for designating import and export of the environment setting information. The screens illustrated in FIGS. 7A and 7B may be displayed according to the instruction input to the screen illustrated in FIG. 5, or may be displayed by the instruction input to a start menu of the OS.

The user selects an export 703 or an import 702 for an item of “operation selection” 701. If the user selects the export 703, the list of the environment setting information illustrated in FIG. 6 is externally output as an export file. If the user selects the import 702, the export file is read, and the environment setting information in the export file is reflected in the document management application 400.

If the user selects the export 703, settings indicated in an area of “settings for installing upgraded version” for an item of “import settings” 711 become further selectable. The “import settings” 711 includes options of “prioritize user settings on older version” 712, “prioritize user settings of exported file” 713, and “select when installing” 714, which will be described in detail below. On the other hand, if the user selects the import 702, an item 715 for designating the export file is displayed as illustrated in FIG. 7B.

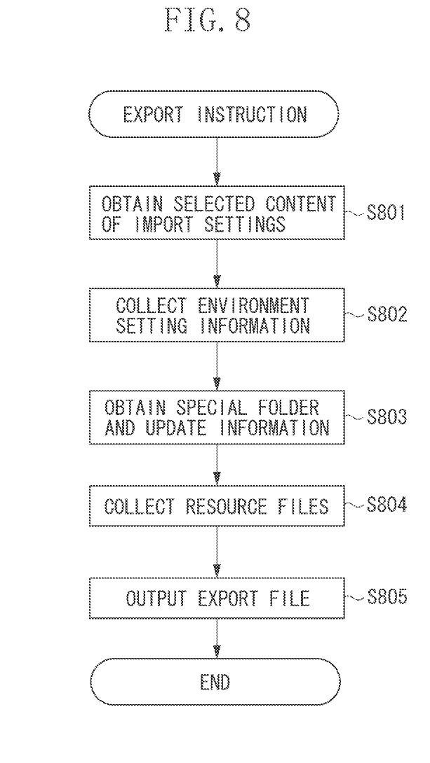

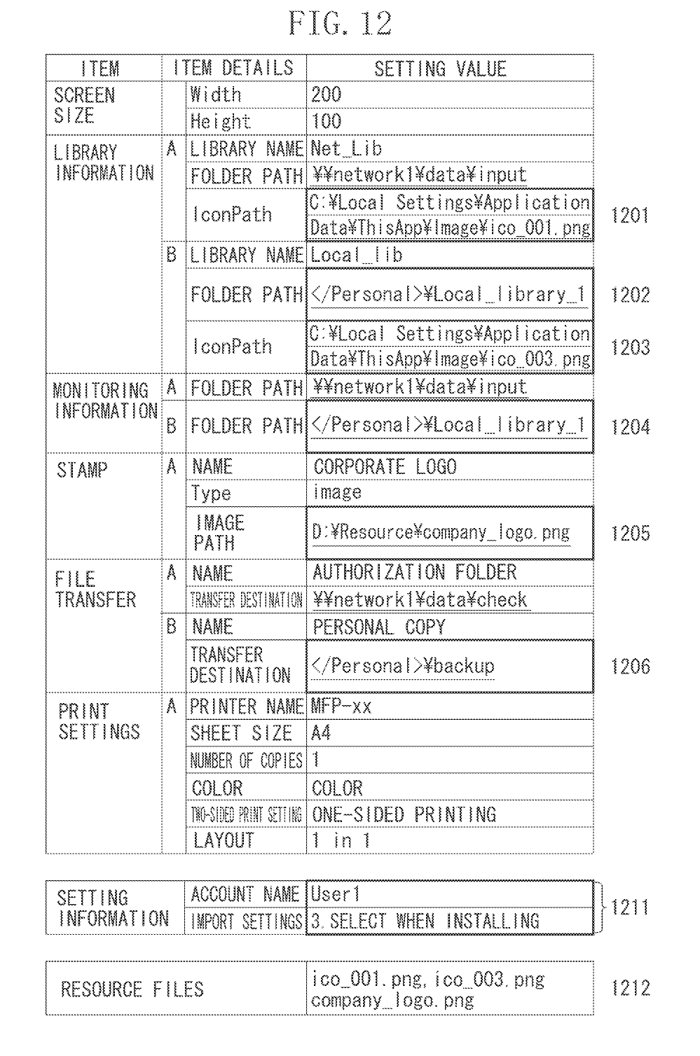

FIG. 8 is a flowchart illustrating export processing performed when the user selects the export 703 and presses an OK button illustrated in FIG. 7A. According to the present exemplary embodiment, each step in the flowchart is realized by the CPU 201 by reading and executing the program related to the process of the flowchart. Further, FIG. 12 is a table illustrating a list of the export file which is an output result of the export processing.

In step S801, the document management application 400 obtains the selected content of the “import settings” 711.

Further, the document management application 400 obtains a user account name, and stores the account name (the creator of the environment setting information) and setting content of the “import settings” 711 as indicated in the setting values of setting information 1211 illustrated in FIG. 12.

In step S802, the document management application 400 collects the environment setting information illustrated in FIG. 6 which becomes base information of the export information illustrated in FIG. 12.

In step S803, the document management application 400 obtains a special folder which is dependent on the OS, and updates a corresponding portion of the export information. The special folder is a folder which is specially handled by the OS, and indicates a local folder storing a program, program data, and user data (My Documents and My Picture). A folder configuration of the special folder may be different depending on a version of the OS. Referring to FIG. 6, the setting values of the folder path indicated in the library information B 612 and monitoring information B 622, and the setting value of a transfer destination indicated in transfer B 642 include the folder path of “My Document”. In the example illustrated in FIG. 6, the folder indicated by C:\Documents and Settings\<User name>\My Documents\ corresponds to “My Documents”.

Since the path (reference information) to “My Documents” may change depending on the version of the OS and the apparatus to be used, the path is converted to </Personal> when exporting. The information is then updated as indicated in the setting values of the folder path in library information B 1202 and monitoring information B 1204, and the setting value of a transfer destination in file transfer B 1206 illustrated in FIG. 12. The special folder is not limited to “My Documents” as in the above-described example. Since the path to the special folder which is OS-dependent may not be usable at a distribution destination of the export file, the process of step S803 is performed.

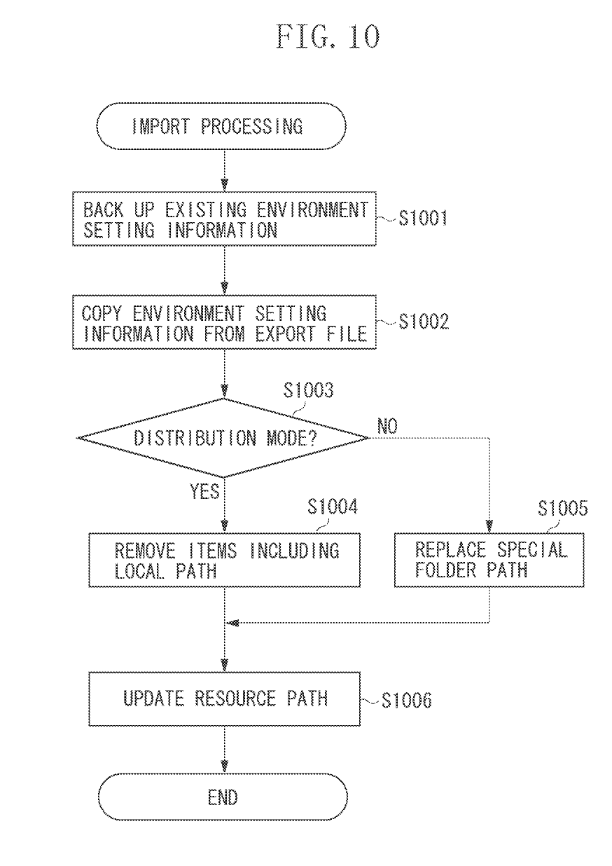

In step S804, the document management application 400 collects resource files of the images, icons, and sounds used by the user for transferring the resource files to the environment of the distribution destination. The resource files include the resource file which has been registered in the document management application 400 when the user has constructed the environment. If such resource files are not transferred to a new environment, the application may not correctly operate, so that the resource files are targets to be transferred. Referring to FIG. 6, the png files for the icons designated in the setting values of IconPath in the library information A 611 and the library information B 612, and an image file (company_logo.png) indicating the corporate logo registered as the setting value of stamp A 631 correspond to the resource files. The resource files are extracted as resource files 1212 illustrated in FIG. 12, and included in the export file. Since the final folder path is different depending on the OS to be imported, the file paths indicating the resources in the setting values of IconPath A 1201, IconPath B 1203, and image path A 1205 are not changed in step S804. Rewriting of the file paths will be described below in a detailed portion of import processing (step S1006 illustrated in FIG. 10).

In step S805, the document management application 400 outputs the export file. The export file includes a setting list, the setting information 1211, and the resource files 1212 as illustrated in FIG. 12. The path related to the special file of the OS in the setting list has been replaced to virtual paths (as indicated in the setting values of the library information B 1202, the monitoring information B 1204, and the file transfer B 1206) as described above.

An output destination of the environment setting information is not limited to the external file, and may be a registry, an on-premise server, a cloud server, or a web server.

Further, the information holding method for the special folder is not limited to a method performed by rewriting the setting information, and other information holding methods may be employed, for example using a conversion table.

### [Import of the Environment Setting Information]

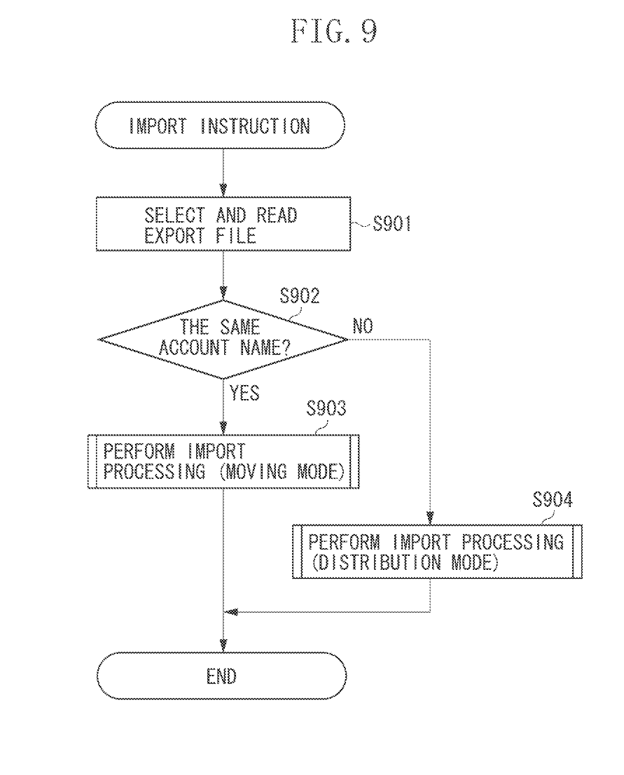

FIG. 9 is a flowchart illustrating the import processing performed when the user selects the import 702 and presses the OK button in the screen illustrated in FIG. 7A.

Upon reception of an instruction for the import processing, in step S901, the document management application 400 selects and reads the export file. More specifically, if the user selects the import 702, the screen illustrated in FIG. 7B is displayed. The user then inputs the reference information of the export file to be read to the input item 715 of the export file. The document management application 400 selects and reads the export file illustrated in FIG. 12 according to the reference information input by the user.

In step S902, the document management application 400 obtains the account name (the user) of the computer which has performed importing, and compares the obtained account name with the account name included in the setting information 1211 illustrated in FIG. 12. If the account names are the same as the result of the comparison (YES in step S902), it indicates that the user who created the environment setting information is using the information. The document management application 400 thus determines that the user has changed the environment thereof, i.e., the mode is a “moving mode”. On the other hand, if the account names are different (NO in step S902), it indicates that the creator has created the environment setting information for another user. The document management application 400 thus determines that the mode is a “distribution mode”.

If the mode is determined to be the “moving mode”, the process proceeds to step S903. In step S903, the document management application 400 performs importing as the moving mode. If the mode is determined to be the “distribution mode”, the process proceeds to step S904. In step S904, the document management application 400 performs importing as the distribution mode.

FIG. 10 is a flowchart illustrating substantial import processing.

In step S1001, the document management application 400 backs up the existing environment setting information. In step S1002, the document management application 400 copies the environment setting information and the resource files in the export file to the new environment.

In step S1003, the document management application 400 determines whether the mode is the distribution mode. The document management application 400 uses the determination result of step S902 illustrated in FIG. 9 in the determination process of step S1003.

If the document management application 400 determines that the mode is the distribution mode (YES in step S1003), it indicates that other users are to use the environment. The information including the local path (the path to the folder used by the creator) thus is not to be available for the user. In step S1004, the document management application 400 removes the items including the local path from the environment setting information.

If the document management application 400 determines that the mode is the moving mode (NO in step S1003), it indicates that the user is to use the past environment setting information, so that the local path is inherited. The process proceeds to step S1005. In step S1005, the document management application 400 replaces the path of the special folder to match the configuration of the OS. Specifically, the path which has been replaced to the virtual path as </Personal> by the folder designation illustrated in FIG. 12 is replaced to “My Document” in the new environment (e.g., “C:\Users\User1\Documents\”).

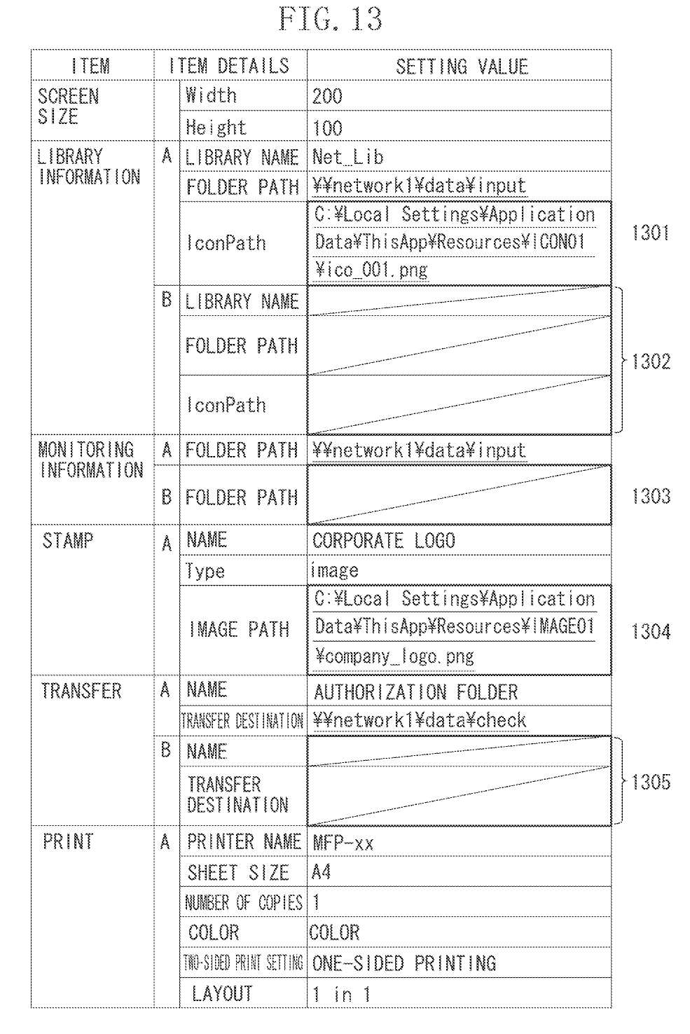

The storing locations of the resource file, such as the icons and the images, are finalized in step S1002. Thus, in step S1006, the document management application 400 updates resource paths to the paths to the location in which the resource files have been stored in step S1002. FIG. 13 is a table illustrating the new environment setting information obtained when the setting list illustrated in FIG. 12 has been imported in the distribution mode. Since the local path has been removed in step S1004, the setting values of library information B 1302, monitoring information B 1303, and transfer B 1305 are deleted. Further, since the resource paths have been updated in step S1006, the setting values of IconPath in library information A 1301 and image path in stamp A 1304 are updated to new paths.

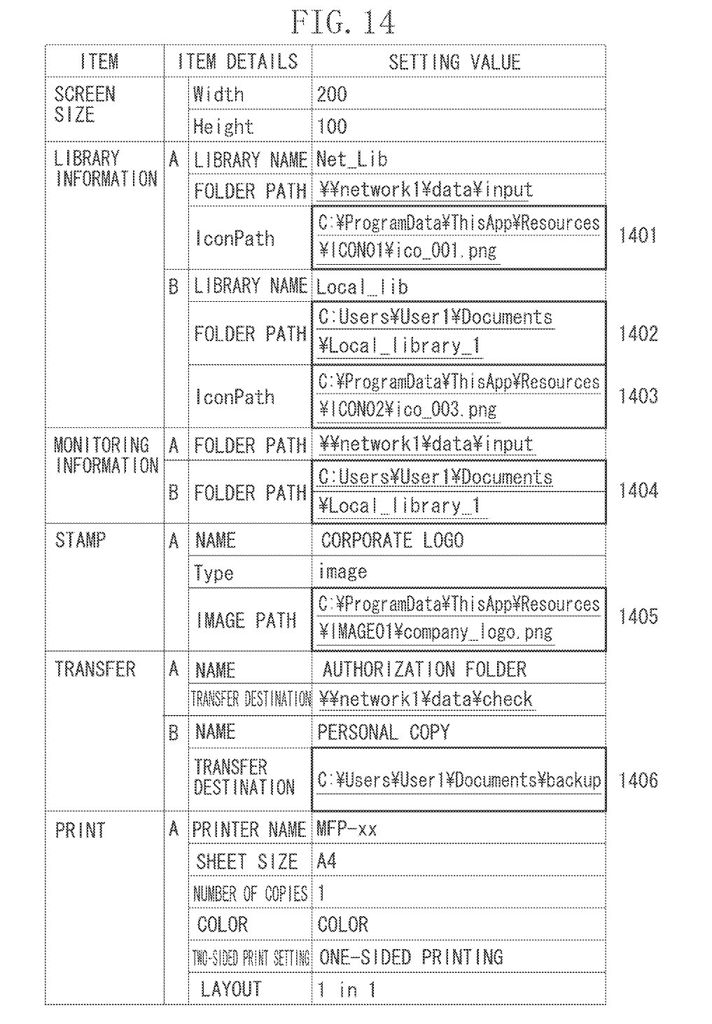

FIG. 14 is a table illustrating the new environment setting information obtained when the setting list illustrated in FIG. 12 is imported by the moving mode. It is assumed that an OS environment of a distribution source has changed. Since the special folder has been replaced in step S1005, the setting value of the folder path in the library information B 1202 illustrated in FIG. 12 is changed to the setting value of folder path in library information B 1402. Further, the setting value of the folder path in the monitoring information B 1204 is changed to the setting value of folder path in monitoring information B 1404, and the setting value of the transfer destination in the transfer B 1206 is changed to the setting value of transfer destination in transfer B 1406. Since the resource path is updated in step S1006, the setting value of IconPath in library information A 1401 and the setting value of image path in stamp A 1405 are updated to new paths.

As described above, according to the present exemplary embodiment, the environment setting information of the application is exported and then imported. As a result, when the application is reinstalled or installed in a different computer, the environment setting information is easily inherited. Even if the export processing is a single operation, the document management application 400 automatically selects between using the moving mode and the distribution mode according to conditions and performs the import processing. In the moving mode, the local path information is inherited. However, if the configuration of the local folder changes due to a change in the OS, the local path automatically adapts to the change. On the other hand, in the distribution mode, the unavailable local path is deleted, and only the available information is imported. As described above, user-friendliness is improved in changing to the new environment.

### [Reflection of the Environment Setting Information at Installation]

According to the first exemplary embodiment, each user performs the import processing in the distribution mode. However, if a large number of users require a similar customized environment at work, it is inconvenient for each user to perform importing. To solve this issue, according to a second exemplary embodiment, the environment setting information of the export file is reflected when the document management application 400 is initially executed.

According to the present exemplary embodiment, it is necessary for the export file to be included in a specific folder before the application is initially activated. The present exemplary embodiment may be realized by embedding the export file in an installer and copying the export file at the installation. However, the method is not limited thereto, and the export file may be downloaded from a server or be automatically distributed. According to the present exemplary embodiment, the specific folder is a folder to which the document management application 400 refers for obtaining the environment setting information.

After the application is installed, default environment setting information is normally set to the document management application 400. According to the present exemplary embodiment, when the document management application 400 is initially activated, the document management application 400 checks the specific folder. If the export file exists in the specific folder, the document management application 400 imports the environment setting information included in the export file.

In such a case, a user may install the document management application 400 for an upgrading purpose in the environment in which a previous version of the document management application is installed. In such an environment, the user may desire to inherit the past environment setting information, or use the environment setting information created by the administrator. Further, the administrator may allow each user to prioritize one's own environment setting information, or make the user use the environment setting information created by the administrator. A method for performing the import processing in consideration of such cases will thus be described below.

As described above, if the user selects the export 703 in the screen illustrated in FIG. 7A, the “import setting” 711 for the “settings for installing upgraded version” becomes selectable. If the user then selects “prioritize user settings on older version” 712, the document management application 400 uses the existing environment setting information when there is the existing environment setting information. Otherwise, the document management application 400 uses the environment setting information in the export file. If the user selects “prioritize user settings of exported file” 713, the document management application 400 ignores the existing environment setting information and uses the environment setting information in the export file. If the user selects “select when installing” 714, the document management application 400 causes the user to select whether to use the existing environment setting information or the environment setting information in the export file. If there is no past environment setting information, the environment setting information in the export file is used regardless of the setting of the “import setting” 711.

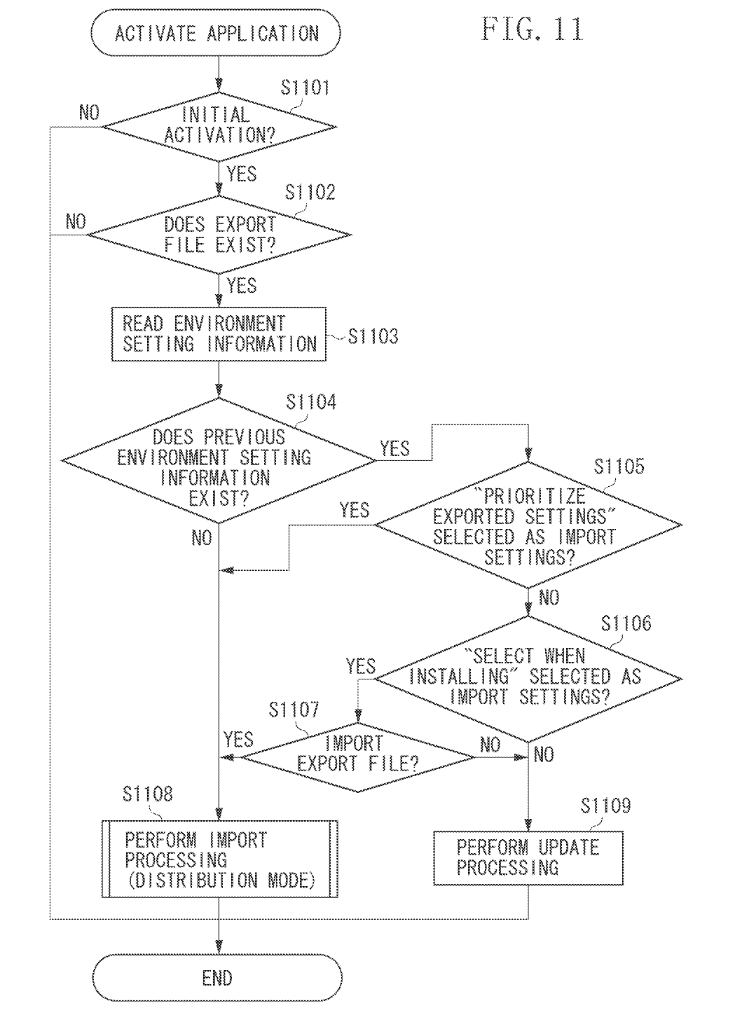

The process for reflecting the environment setting information after installing the application will be described below with reference to the flowchart illustrated in FIG. 11.

In step S1101, the document management application 400 determines whether the application is initially activated. If the application is initially activated after installation or after the installation of the upgraded version (YES in step S1101), the process proceeds to step S1102. In step S1102, the document management application 400 determines whether the export file exists in the specific folder. If the export file exists in the specific folder (YES in step S1102), the process proceeds to step S1103. In step S1103, the document management application 400 reads the export file.

In step S1104, the document management application 400 determines whether there is previous environment setting information (of the past version). If there is no previous environment setting information (NO in step S1104), the process proceeds to step S1108.

If there is the previous environment setting information (YES in step S1104), the document management application 400 performs the process according to the “import setting” 711. The document management application 400 thus refers to the setting values of import settings in the setting information 1211 illustrated in FIG. 12 for obtaining the content of the selected “import setting” 711.

In step S1105, the document management application 400 determines whether the selected import setting is “prioritize user settings of exported file” 713. If the selected import setting is “prioritize user settings of exported file” 713 (YES in step S1105), the process proceeds to step S1108.

On the other hand, if the selected import setting is not “prioritize user settings of exported file” 713 (NO in step S1105), the process proceeds to step S1106. In step S1106, the document management application 400 determines whether the selected import setting is “select when installing” 714. If the selected import setting is not “select when installing” 714 (NO in step S1106), it indicates that the selected import setting is “prioritize setting of old version” 712. The process then proceeds to step S1109. If the selected import setting is “select when installing” 714 (YES in step S1106), the process proceeds to step S1107. In step S1107, the document management application 400 receives the selection of whether to import the export file or update using the previous environment setting information. Specifically, a selection screen for selecting the environment setting information to be used is displayed. If the export file is selected to be used (YES in step S1107), the process proceeds to step S1108. If the existing environment setting information is selected to be used (NO in step S1107), the process proceeds to step S1109.

In step S1108, the document management application 400 performs the import processing in the distribution mode. In other words, the document management application 400 performs the process described with reference to FIG. 10. If the import processing is performed via the determination processes in step S1105 or step S1107, the existing environment setting information is replaced. A message notifying the user that the existing environment setting information will become unavailable may then be displayed.

In step S1109, the document management application 400 performs update processing. Specifically, the document management application 400 performs the process for inheriting the existing environment setting information (of the past version) without any changes, or performs a process for adapting the environment setting information according to upgrading of the document management application 400 and changes settings from the default setting. In such a case, the export file is not used. The process for adapting includes, for example, writing an initial value of a function which has been newly added as a result of upgrading the document management application 400, and correcting the environment setting information according to the format obtained after upgrading. Furthermore, if the OS is upgraded, the existing environment setting information may be unusable as is. The document management application 400 thus replaces the path of the special folder included in the existing environment setting information to the path indicated by the upgraded OS.

If the document management application 400 determines that the activation is not the initial activation (NO in step S1101), or determines that the export file does not exist (NO in step S1102), the document management application 400 ends the process without performing the process using the export file.

If there is a large number of users working in the customized environment, the new environment setting information can be transferred when installing the application by performing the above-described process. As a result, the load of importing can be reduced, and user-friendliness is improved.

According to the first and second exemplary embodiments, when the import processing is performed, the local path is deleted from the environment setting information. Alternatively, the process for the local path in the export processing can be performed. Specifically, when performing the export processing, the user selects export processing for distribution purposes or for moving purposes. If the user selects the export processing for distribution purposes, the document management application 400 may delete the information on the local path from the environment setting information to be exported (i.e., perform the process of step S1004).

The above-described exemplary embodiments maybe realized by providing software (program) for implementing the functions of the above-described exemplary embodiments to a system or an apparatus via a network or various types of recording devices, and a computer (or a CPU or a micro-processing unit (MPU) in the system or the apparatus reading and executing the program.

According to the above-described exemplary embodiments, the operation desired by the user can be realized even in a case where the user uses the environment setting information.

While the present disclosure has been described with reference to exemplary embodiments, it is to be understood that these embodiments are not seen to be limiting. The scope of the following claims is to be accorded the broadest interpretation so as to encompass all such modifications and equivalent structures and functions.

This application claims the benefit of Japanese Patent Application No. 2013-176245 filed Aug. 28, 2013, which is hereby incorporated by reference herein in its entirety.

What is claimed is:

1. An image processing apparatus comprising:
an identification unit configured to identify environment setting information in which setting contents of an application is described;
a determination unit configured to determine whether information indicating a creator of the environment setting information described in the environment setting information is the same as information indicating a user of the application; and
an import unit configured to import, in a case where the determination unit determines that the information indicating a creator of the environment setting information is not the same as the information indicating a user of the application, the environment setting information so that a path to a folder to be used by the creator included in the environment setting information is not applied to the application.

2. The information processing apparatus according to claim 1, wherein in a case where the determination unit determines that the information indicating a creator of the environment setting information is the same as the information indicating a user of the application, the import unit updates a path to a special folder which is dependent on an operating system included in the environment setting information to a path to a special folder which is dependent on an operating system of an environment in which the environment setting information is to be used.

3. The information processing apparatus according to claim 1, wherein the import unit deletes the path to the folder to be used by the creator included in the environment setting information.

4. The information processing apparatus according to claim 1, further comprising:
a display control unit configured to display a selection screen including at least export of the environment setting information and import of the environment setting information as items to be selected,
wherein the display control unit displays, in a case where the import of the environment setting information has been selected, a screen that receives input of information for identifying the environment setting information, and displays, in a case where the export of the environment setting information has been selected, a screen that receives a selection of whether the environment setting information to be exported is prioritized.

5. A computer-readable storage medium storing a program for causing a computer to execute a method, the method comprising:
identifying environment setting information in which setting contents of an application is described;
determining whether information indicating a creator of the environment setting information described in the environment setting information is the same as information indicating a user of the application; and
importing, in a case where it is determined that the information indicating a creator of the environment setting information is not the same as the information indicating a user of the application, the environment setting information so that a path to a folder to be used by the creator included in the environment setting information is not applied to the application.

6. The computer-readable storage medium according to claim 5, wherein in a case where it is determined that the information indicating a creator of the environment setting information is the same as the information indicating a user of the application, a path to a special folder which is dependent on an operating system included in the environment setting information is updated to a path to a special folder which is dependent on an operating system of an environment in which the environment setting information is to be imported.

7. The computer-readable storage medium according to claim 5, wherein the path to the folder to be used by the creator included in the environment setting information is deleted.

8. The computer-readable storage medium according to claim 5, further comprising:
displaying a selection screen including at least export of the environment setting information and import of the environment setting information as items to be selected,
wherein, in a case where the import of the environment setting information has been selected, a screen that receives input of information for identifying the environment setting information is displayed, and in a case where the export of the environment setting information has been selected, a screen that receives a selection of whether the environment setting information to be exported is prioritized is displayed.

9. A control method comprising:
identifying environment setting information in which setting contents of an application is described;
determining whether information indicating a creator of the environment setting information described in the environment setting information is the same as information indicating a user of the application; and
importing, in a case where it is determined that the information indicating a creator of the environment setting information is not the same as the information indicating a user of the application, the environment setting information so that a path to a folder to be used by the creator included in the environment setting information is not applied to the application.

10. The control method according to claim 9, wherein in a case where it is determined that the information indicating a creator of the environment setting information is the same as the information indicating a user of the application, a path to a special folder which is dependent on an operating system included in the environment setting information is updated to a path to a special folder which is dependent on an operating system of an environment in which the environment setting information is to be used, in the importing.

11. The control method according to claim 9, wherein the path to the folder to be used by the creator included in the environment setting information is deleted.

12. The control method according to claim 9, further comprising displaying:
a selection screen including at least export of the environment setting information and import of the environment setting information as items to be selected,
wherein in a case where the import of the environment setting information has been selected, a screen that receives input of information for identifying the environment setting information is displayed, and in a case where the export of the environment setting information has been selected, a screen that receives a selection of whether the environment setting information to be exported is prioritized is displayed, in the displaying.
